(19) United States
(12) Patent Application Publication
(10) Pub. No.: US 2010/0192650 A1
(43) Pub. Date: Aug. 5, 2010

(54) SELF-ADJUSTING CYLINDER MONITOR ASSEMBLY

(75) Inventors: Tracy F. Fowler, West Haven, CT (US); Brian R. Fournier, Canton, CT (US); Damon J. Lenk, Bristol, CT (US); Scott Morstatt, Lenoir City, TN (US)

Correspondence Address: MOORE & VAN ALLEN PLLC, P.O. BOX 13706, Research Triangle Park, NC, 27709, US

(73) Assignee: CORBIN RUSSWIN ARCHITECTURAL HARDWARE, Berlin, CT (US)

(21) Appl. No.: 12/697,800

(22) Filed: Feb. 1, 2010

Related U.S. Application Data
(60) Provisional application No. 61/148,519, filed on Jan. 30, 2009.

(51) Int. Cl. E05B 17/00; E05B 45/06; E05B 29/00; H01H 1/66

(52) U.S. Cl. 70/357; 70/431; 335/153

(57) ABSTRACT

A cylinder lock monitoring assembly for monitoring position of a lock cylinder. The monitoring assembly includes a housing having an inner cavity and an exterior diameter. The exterior diameter of the housing is not significantly greater than the corresponding cylinder diameter. The assembly further includes a switch received into the inner cavity of the housing. The switch is in electrical communication with an indicator. The switch is reactive to any change in position of the lock cylinder.

### CROSS-REFERENCES

This application is related to U.S. provisional application No. 61/148,519, filed Jan. 30, 2009, entitled “Self-Adjusting Cylinder Monitor Assembly”, naming Tracy F. Fowler, Brian R. Fournier and Damon John Lenk as inventors. The contents of the provisional application are incorporated herein by reference in their entirety, and the benefit of the filing date of the provisional application is hereby claimed for all purposes that are legally served by such claim for the benefit of the filing date.

### BACKGROUND

This invention relates generally to lock monitoring systems, and more particularly to a lock monitoring system for determining the position of a lock cylinder in a mortise lock assembly.

There are a number of different ways that users have attempted to make locks “tamper proof” using lock monitoring systems. Some systems incorporate alarms associated with the insertion of an incorrect key into a lock cylinder. The alarms cooperate with the inner workings of the lock cylinder, such as the pin/tumbler assembly, to signal when there is tampering with the pin/tumbler assembly within the cylinder. The alarms provide an audio or visual indication, or trigger a locking mechanism, when the pins within the lock cylinder are improperly manipulated.

Other conventional lock monitoring systems signal an alarm when the lock assembly is being pried or jimmied or otherwise forcibly engaged. The lock assembly includes sensors and, when there is an attempt to pry or damage the lock assembly or surrounding frame, the sensors signal an alarm.

Lock monitoring systems do not typically address the position of the lock cylinder. In a mortise lock assembly, the lock cylinder rotates a cam to place the lock in a locked condition or an unlocked condition, as well as to retract a latch or a deadbolt to a retracted position. Therefore, the rotation of the lock cylinder is usually an indication of either ingress or egress through the door.

Mortise lock assemblies vary in size and depth. Similarly, lock cylinders also vary in size and depth, as does the shape and design of the cam. Thus, it is difficult to provide a lock monitoring system for a lock cylinder that will work effectively with all mortise lock assemblies and lock cylinders.

For the foregoing reasons, there is a need for a lock monitoring system that monitors the position of the lock cylinder. The new lock monitoring system should signal an alarm, or be integrated into an alarm system where rotation of the lock cylinder may be monitored for security reasons. Ideally, the new lock monitoring system should be applicable to new and existing mortise lock assemblies, especially in a retrofit application.

### SUMMARY

The present invention provides for a cylinder lock monitor for monitoring the cylinder position. The monitor has a housing having an inner cavity and an exterior diameter, the exterior diameter being no greater than the corresponding cylinder diameter. The monitor also includes a switch received into the inner cavity of the housing. The switch is in electrical communication with an indicator. The monitor also includes a spring for urging the switch into the inner cavity of the housing, and a retainer for holding the spring adjacent to the switch.

The present invention further provides for a cylinder lock assembly having a cylinder lock, and a cylinder lock monitor for monitoring the cylinder's position. The cylinder lock monitor includes a housing having an inner cavity and an exterior diameter, the exterior diameter being no greater than the corresponding cylinder diameter, a switch received into the inner cavity of the housing, the switch in electrical communication with an indicator, a spring for urging the switch into the inner cavity of the housing, and a retainer for urging the spring to remain adjacent to the switch.

Another aspect of the present invention provides for a mortise lock assembly having a mortise lock body, a cylinder lock, and a cylinder lock monitor assembly for monitoring the cylinder's position. The cylinder lock monitor assembly has a housing having an inner cavity and an exterior diameter, the exterior diameter being no greater than the corresponding cylinder diameter. The cylinder lock monitor assembly further includes a switch received into the inner cavity of the housing, the switch in electrical communication with an indicator. The cylinder lock monitor assembly also includes a spring for urging the switch into the inner cavity of the housing, and a retainer for urging the spring to remain adjacent to the switch.

### BRIEF DESCRIPTION OF THE DRAWINGS

FIG. 1A is an exploded perspective view of a mortise lock assembly.

FIG. 1B is a perspective view of an embodiment of a lock cylinder monitoring assembly as shown in FIG. 1.

FIGS. 2A and 2B are exploded views from opposite sides of the lock cylinder monitoring assembly and lock cylinder as shown in FIG. 1A.

FIG. 3 is a front elevation view of the lock cylinder monitoring assembly as shown in FIG. 2.

FIG. 4 is a cross-section view of the lock cylinder monitoring assembly taken along line 4-4 of FIG. 3.

FIG. 5 is cross-section view of the lock cylinder monitoring assembly taken along line 5-5 of FIG. 3.

FIG. 6A is a side elevation view of the lock cylinder monitoring assembly and lock cylinder as shown in FIG. 1 in a first position relative to a mortise lock housing.

FIG. 6B is a side elevation view of the lock cylinder monitoring assembly and lock cylinder as shown in FIG. 6A in a second position relative to a mortise lock housing.

FIG. 7A is an elevation view of a cam of a lock cylinder and a portion of a lock cylinder monitoring assembly in a first relative position taken along line 7A-7A of FIG. 3.

FIG. 7B is an elevation view of the cam and the portion of the lock cylinder monitoring assembly as shown in FIG. 7A in a second relative position.

FIGS. 8A and 8B are a perspective view and an exploded perspective view, respectively, of another embodiment of a lock cylinder monitoring assembly.

FIGS. 9A and 9B are a perspective view and an exploded perspective view, respectively, of the lock cylinder monitoring assembly shown in FIGS. 8A and 8B from the opposite side as shown in FIGS. 8A and 8B.

FIG. 10 is a front elevation view of the lock cylinder monitoring assembly as shown in FIGS. 8A-9B.

FIG. 11 is a cross-section view of the lock cylinder monitoring assembly taken along line 11-11 of FIG. 10.

FIG. 12 is cross-section view of the lock cylinder monitoring assembly taken along line 12-12 of FIG. 10.

FIG. 13A is a side elevation view of the lock cylinder monitoring assembly and lock cylinder as shown in FIGS. 8A-9B in a first position relative to a mortise lock housing.

FIG. 13B is a side elevation view of the lock cylinder monitoring assembly and lock cylinder as shown in FIG. 13A in a second position relative to a mortise lock housing.

### DESCRIPTION

The embodiments of a lock cylinder monitoring assembly described herein is for use in a mortise lock and may be used with any conventional mortise lock such as, for example, the mortise locks described by U.S. Pat. No. 6,393,878 and U.S. Pat. No. 6,349,982, the contents of which are hereby incorporated by reference. Accordingly, detailed explanations of the functioning of all of the components of the mortise lock are deemed unnecessary for understanding of the present invention by one of ordinary skill in the art.

Certain terminology is used herein for convenience only and is not to be taken as a limitation on the invention. For example, words such as “interior”, “exterior”, “upper,” “lower,” “left,” “right,” “horizontal,” “vertical,” “upward,” and “downward” merely describe the configuration shown in the FIGs. Indeed, the components may be oriented in any direction and the terminology, therefore, should be understood as encompassing such variations unless specified otherwise.

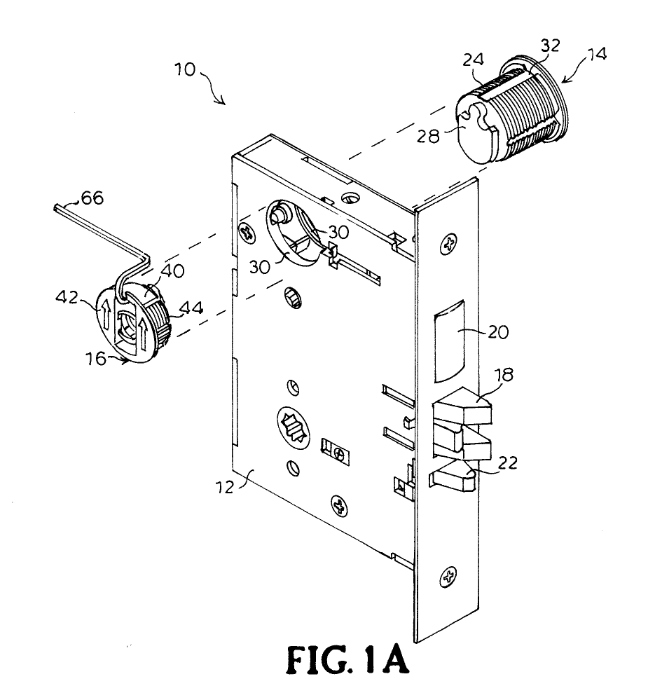

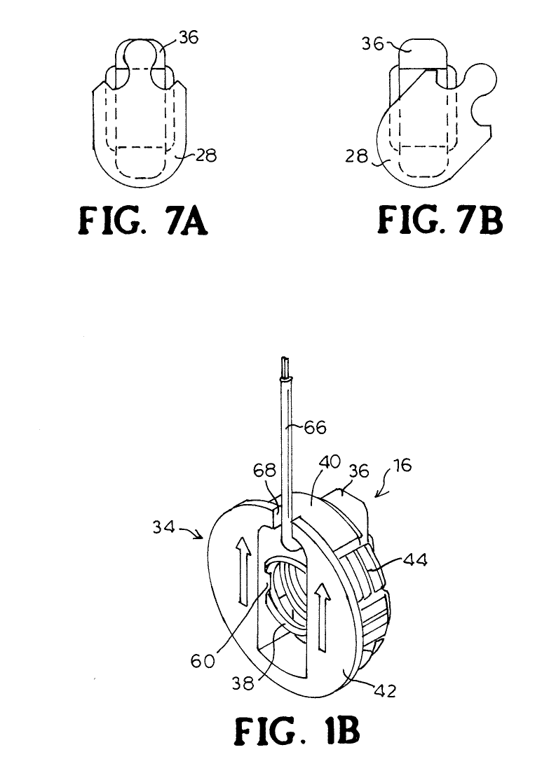

Referring now to the drawings, wherein like reference numerals designate corresponding or similar elements throughout the several views, FIGS. 1A and 1B shows an embodiment of a mortise lock assembly generally designated at 10. The mortise lock assembly 10 is conventional and only a few of the mortise lock components are shown, including a lock case 12 and a key-operated lock cylinder 14. Also shown in FIG. 1 is an embodiment of a lock cylinder monitoring assembly, generally designated at 16.

As is known in the art, the mortise lock case 12 is adapted to fit into a mortised recess formed in the edge of a door (not shown) which is opposite to the edge of the door that is hinged to a door frame. The lock case 12 is generally rectangular and encloses the lock components. The principal lock components are a beveled latch bolt 18, a deadbolt 20 and an auxiliary bolt 22. Both of the latch bolt 18 and the deadbolt 20 may project from the case 12 beyond the edge of the door and into openings in the door frame to latch or lock the door in a closed position. The latch bolt 18 and deadbolt are moveable to a retracted position inside the case 12 to permit opening of the door by operation of a latch operator (not shown), such as a door knob or lever handle.

The lock cylinder 14 has an elongated threaded body 24. The cylinder body 24 accommodates a rotatable key plug 26, the inner end of which carries an eccentric cam 28. Rotation of the key plug 26 by a key in the cylinder body 24 causes corresponding rotation of the cam 28. The major side walls of the lock case 12 define opposed circular openings 30 in the upper rear corners for threadably receiving the lock cylinder 14. During installation of the mortise lock 10, a transverse opening is drilled in a face of the door and opens into the recess in the edge of the door. The transverse opening is positioned to align with the openings in the lock case 12 when the lock case 12 is in the recess. The lock cylinder 14 is inserted into the transverse opening and threaded into the opening 30 on one side of the lock case 12. The lock cylinder 14 is advanced into the lock case 12 until an outer trim flange 32 is flush against the door surface. The distance the cylinder body 24 advances into the lock case 12 will vary based on the thickness of the door.

As is known in the art, the cam 28 is adapted to operatively engage lock components to effect a locked condition and an unlocked condition of the mortise lock 10. Optionally, the cam 28 may function to selectively extend and retract the deadbolt 20 or retract the latch bolt 18. All of the operations of the cam 28 require rotation of a key in the lock cylinder 14 for rotating the key plug 26 and the cam 28.

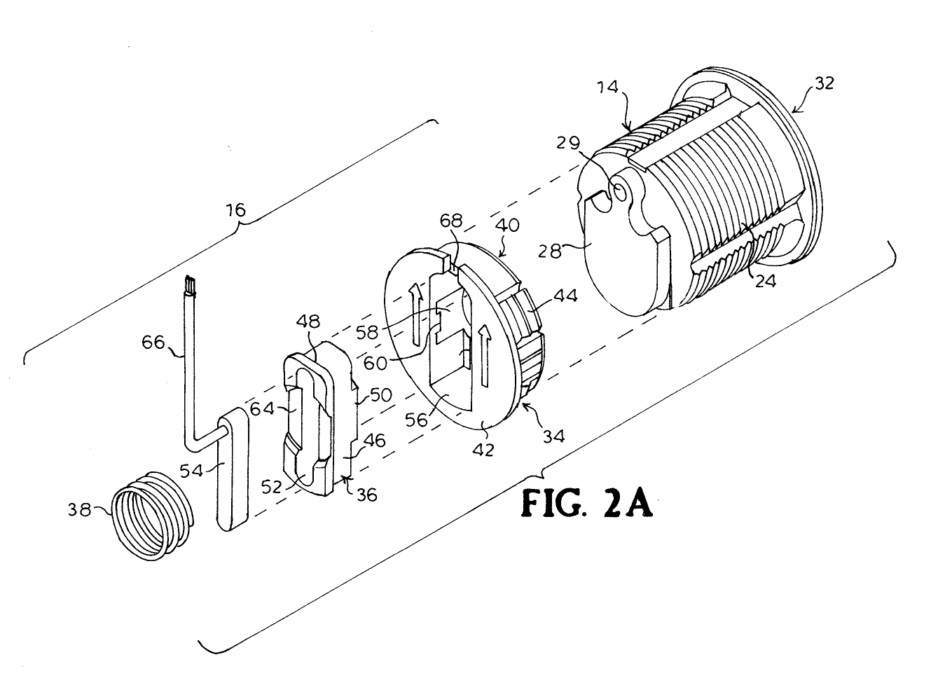

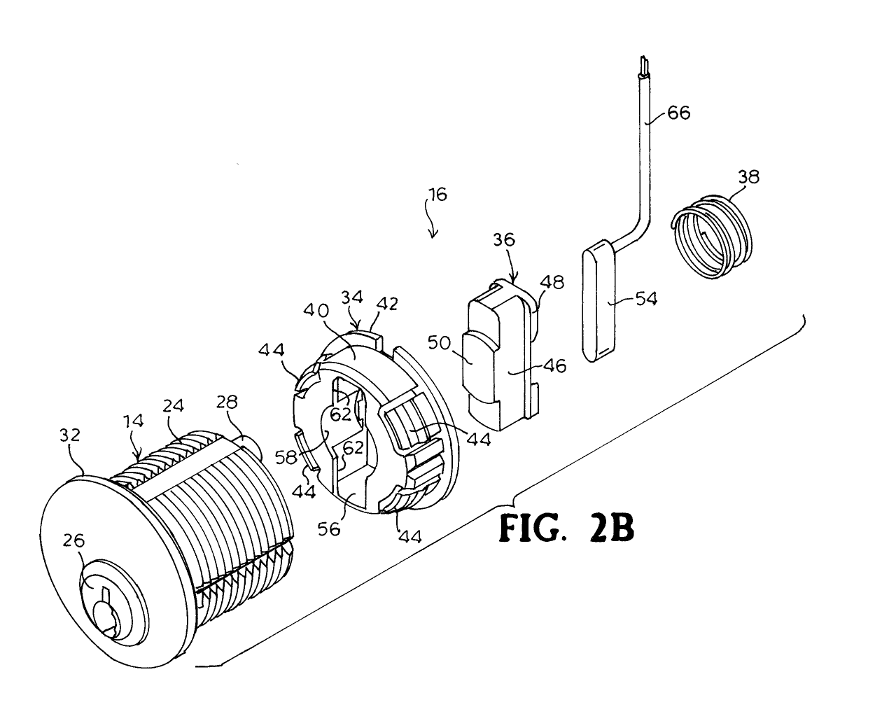

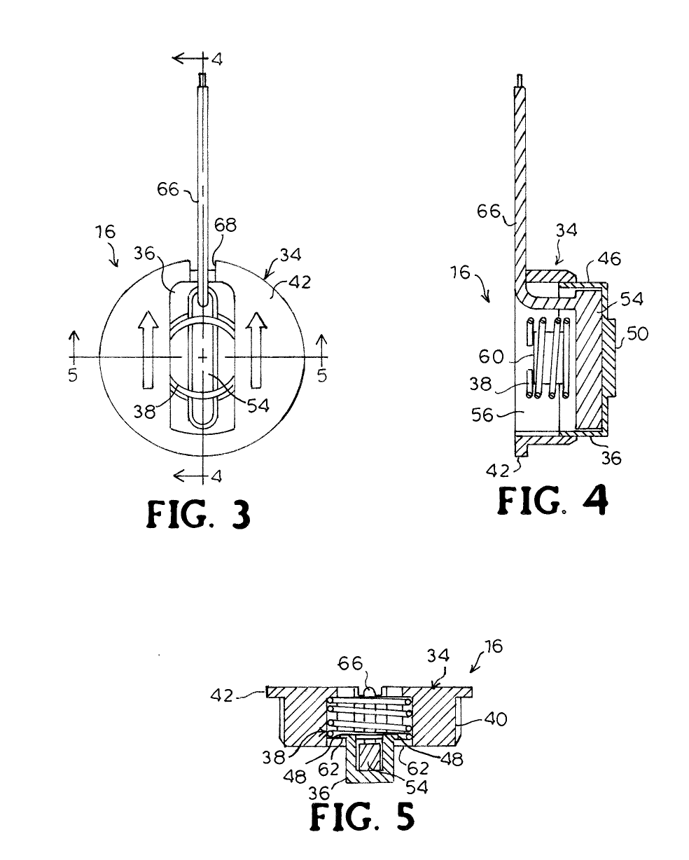

Referring to FIGS. 2A and 2B, the lock cylinder monitoring assembly 16 comprises a housing 34, a plunger 36 and a coil spring 38. The monitor housing 34 is a generally circular member, including an inner portion 40 of some depth and a generally planar outer flange portion 42. The outer flange portion 42 has a larger diameter than the inner portion 40 of the housing. The periphery of the inner portion 40 of the housing includes four flexible tabs 44 depending inwardly from the flange portion 42.

The plunger 36 is a generally rectangular member, including an inner portion 46 of some depth and a generally planar outer flange portion 48 of slightly larger dimensions than the inner portion 46 of the plunger 36. The inner portion 46 of the plunger 36 has an axial boss 50 extending partially along the inner surface. The plunger 36 defines an oblong recess 52 for receiving a switch 54. The switch 54 is fixed within the recess 54 using any number of suitable adhering means such as the application of an adhesive such as glue. Other methods of fixing the switch 54 within the plunger recess 52 are contemplated. They include but are not limited to mechanical means such as screws and pins, as well as other chemical means such as epoxy resin, as well as heat so as to melt the switch 54 within the recess 52. In an assembled position, the switch 54 is completely embedded within the switch recess 52 in the plunger 36.

The monitor housing 34 defines a pass through opening 56 which is sized and shaped to slidably receive the plunger 36. A pair of opposed arcuate walls 58 further define the opening 56 at the midpoint and partially form a spring recess. A pair of opposed axial tabs 60 extend inwardly into the arcuate portions of the opening 56. The inner end of the opening 56 is defined by end walls 62 that extend transversely for partially closing the opening 56.

To assemble the lock cylinder monitoring assembly 16, the plunger 36 and switch 54 are slipped into the opening 56 in the housing 34. The plunger 36 slides freely within the housing 34. Inward axial movement of the plunger 36 is limited by engagement of the outer flange portion 48 of the plunger 36 with the end walls 62 at the inner end of the opening 56. The spring 38 is then placed within the opening 56 in the spring recess partially defined by the arcuate inner walls 58 of the housing 34. The outer surface of the plunger 36 defines a partial circular recess 64 for receiving the inner end of the spring 38. The spring 38 is held in compression by positioning the outer coil under the tabs 60. The spring 38 thus serves to hold the plunger 36 within the housing 34 while biasing the plunger 36 against the end walls 62, as best seen in FIGS. 4 and 5. It is understood that other means for inwardly biasing the plunger 36 are possible. Thus, we do not intend ourselves to limit to the specific embodiments of the spring biasing means shown herein.

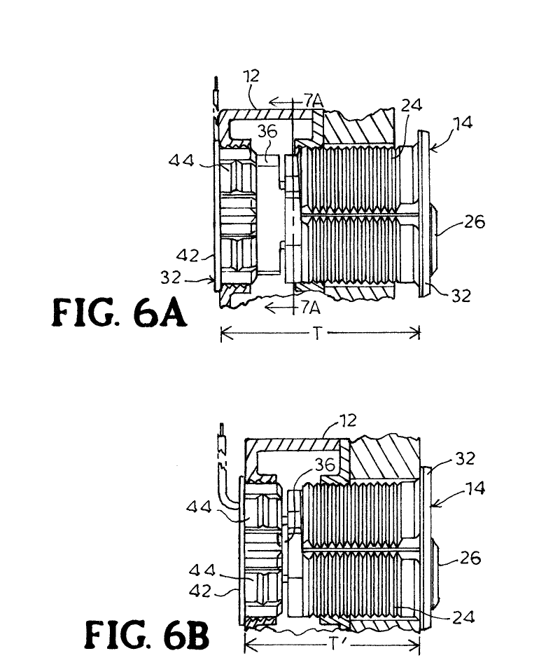

The inner portion 40 of the monitor housing 34 is sized to be received in the cylinder opening 30 in the case 12 opposite the lock cylinder 14. Referring to FIGS. 6A and 6B, the inner portion 40 of the housing 34 is press fit into the opening 30 in the case 12. As the housing 34 advances into the case 12, the flexible tabs 44 on the flange portion of the housing 34 engage the case 12 adjacent the opening 30 and flex inwardly. As the housing 34 advances into the case 12, the tabs 44 clear the wall of the case 12 and snap outwardly. Ridges on the tabs thus engage the inner surface of the wall for holing the lock cylinder monitoring assembly 16 in the lock case 12.

As described above, during installation of the mortise lock 10, the lock cylinder 14 is inserted through an opening in the door face and threaded into the opening 30 in the lock case 12. As the lock cylinder 14 is threaded into the case 12, the boss 50 on the plunger 36 initially engages the cam 28 of the lock cylinder 14. As the lock cylinder 14 advances, the plunger 36 is pushed into the housing 34 against the force of the spring 38 until the trim flange 32 on the lock cylinder 14 is flush against the door surface. Thus, the lock cylinder monitoring assembly 16 is able to accommodate varying depths of lock cylinder 14 intrusion into the case based lock cylinder bodies 24 of varying lengths and varying door thicknesses.

In an assembled position, the lock cylinder 14 and the lock cylinder monitoring assembly 16 make frictional contact at the cam 28 and the boss 50. A magnet 29 is embedded flush with the surface of the cam 28 so that the cam 28 is free to rotate within the lock case 12. In one embodiment, the switch 54 is a Reed switch, which operates by an applied magnetic field. The switch 54 has at least one pair of electrical contacts (not shown) therein. The contacts remain either normally open or normally closed when a magnetic field is applied. In one embodiment, the contacts within the switch 54 are normally closed when a magnetic field is applied. Thus, if the magnet 25 were to move upon rotation of the cam 24, the switch 54 would open at the absence of a magnetic field for generating an electric signal indicating that the cam 28 has moved. As seen in the FIGs., electrical wiring 66 is provided for electrically connecting the switch 54. A radial notch 68 in the flange portion 42 of the housing 34 is sized and dimensioned to pass the wire 66.

FIG. 7A shows the cam 28 in an initial home position where switch 54 is aligned with the magnet 29 embedded in the cam 28. When a key is inserted in the key plug 26, the key, key plug 26 and cam 28 can rotate together for effecting a lock function. FIG. 7B shows the position of the cam 28 after rotation from the home position. When the cam 28 rotates, the magnet 29 moves away from the switch 54. Because the switch 54 is able to indicate presence or loss of magnetic field, if the switch 54 is normally closed the switch 54 opens and thus disrupts the normal flow of current in the circuit. This sends an electrical signal over the wire 66 generally indicating that the cam 28 has moved from its home position.

The wire 66 from the switch 54 may be connected to a remote alarm or other indicator (not shown). The indicator may be an audio or visual signal, or may be connected to an alarm/security system where the signal from the indicator may be recorded as an event for security auditing, shunt an alarm when cylinder use is acceptable (i.e. cylinder used to open door instead of electronic credential (keycard, pin code)), or notify security or initiate an alarm at a time when cylinder use is not acceptable. Uses of the signal from the switch 54 may be expanded to accommodate specific security requirements as well as alarm system monitoring capabilities.

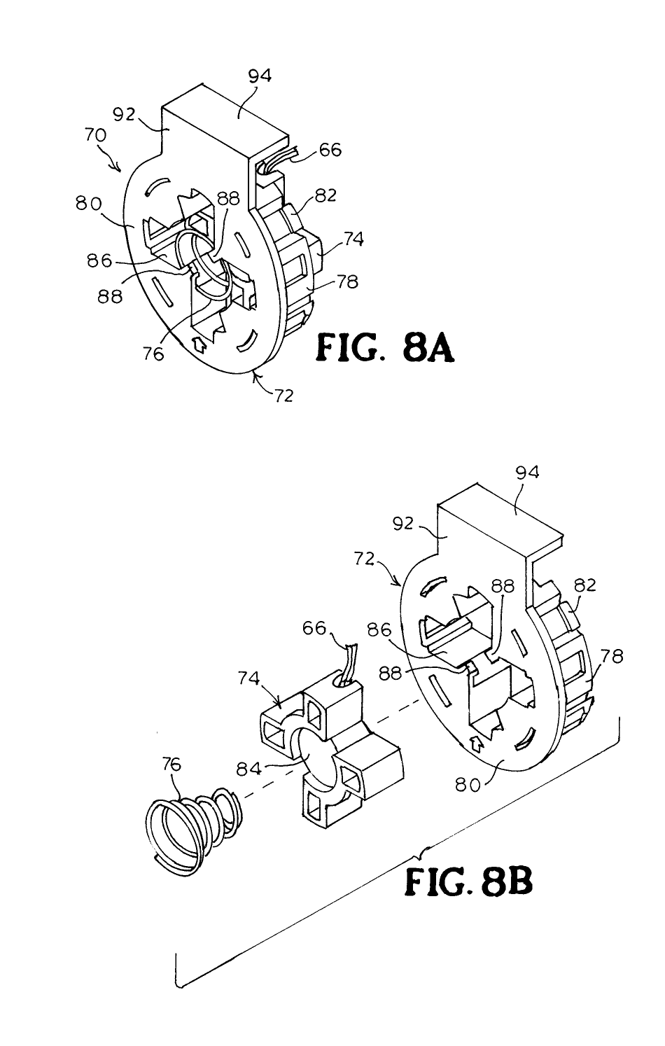

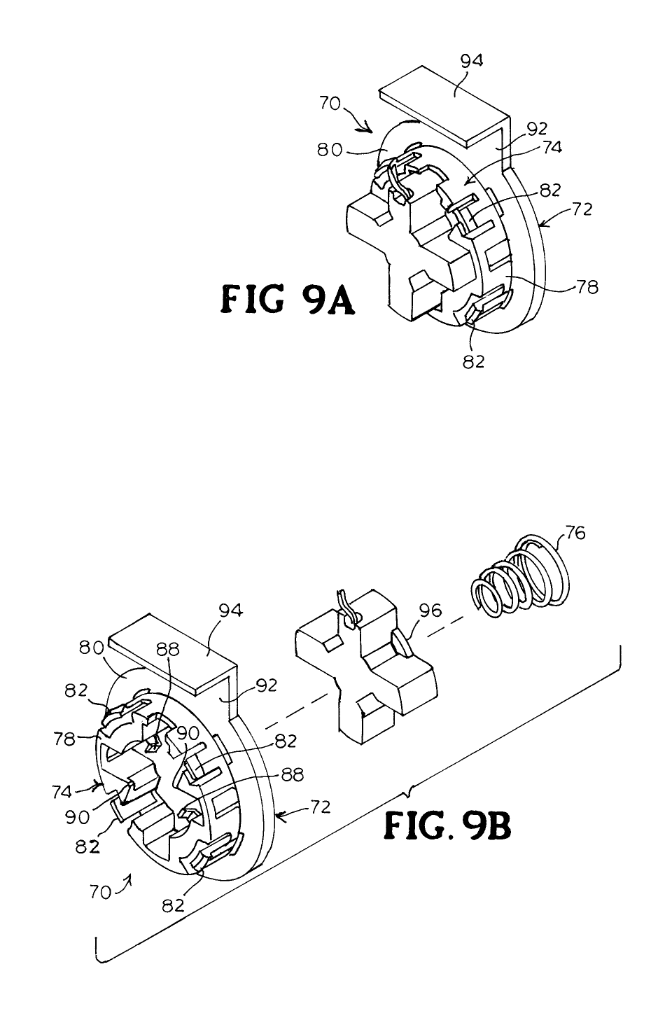

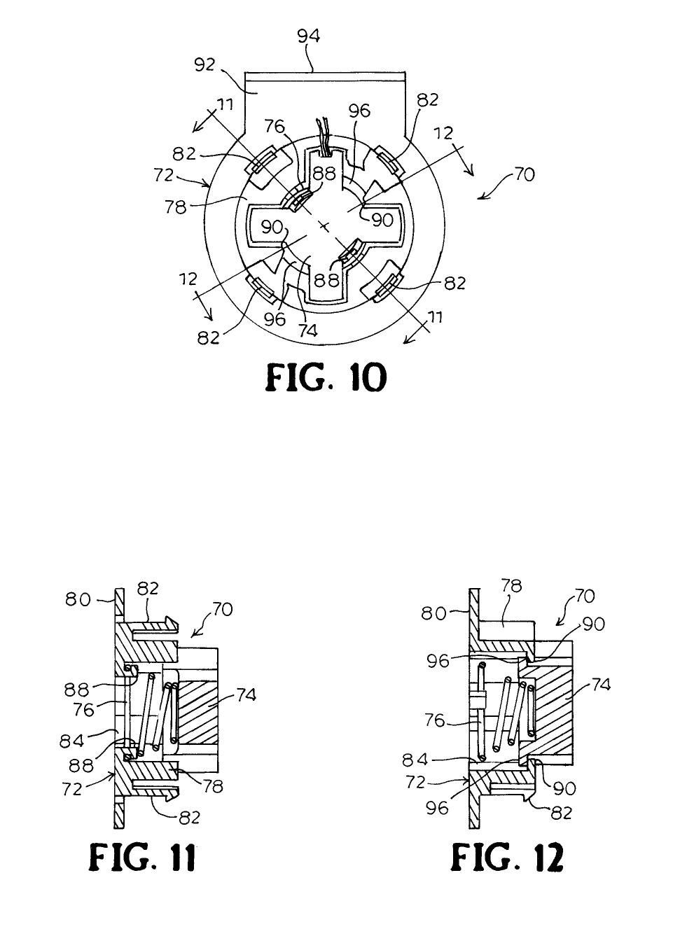

Referring now to FIGS. 8A-9B, another embodiment of a cylinder lock monitoring assembly is shown and generally designated at 70. The lock cylinder monitoring assembly 70 comprises a housing 72, a plunger 74 and a coil spring 76. As in the previous embodiment, the monitor housing 72 is a generally circular member, including an inner portion 78 and an outer flange portion 80 of a larger diameter and including four inwardly depending flexible tabs 82. In this embodiment, the outer flange portion 80 further comprises a planar extension 92 which projects upwardly and terminates in a perpendicular flange 94 that extends inwardly from the extension 92.

The plunger 74 is a generally X-shaped member. The plunger 74 defines a central circular blind bore 84 for receiving the spring 76. A switch sensitive to a magnetic filed is integral with the plunger 74. The monitor housing 72 defines an X-shaped pass through opening 86 which is sized and shaped to slidably receive the plunger 74. A pair of opposed axial tabs 88 extend inwardly into the opening 86. The housing 72 also has a pair of opposed axial tabs 90 at the inner end of the opening 86 that extend transversely into the opening 86.

To assemble the lock cylinder monitoring assembly 70, the plunger 74 is slipped into the opening 86 in the housing 72 and slides freely within the housing 72. Inward axial movement of the plunger 74 is limited by engagement of the tabs on walls 96 connecting the legs of the plunger 74. The spring 76 is then placed within the 84 and positioning the outer coil under the tabs 88. As in the previous embodiment, the spring 76 thus serves to hold the plunger 74 within the housing 72 while biasing the plunger 74 inwardly against the tabs 90, as best seen in FIGS. 11 and 12.

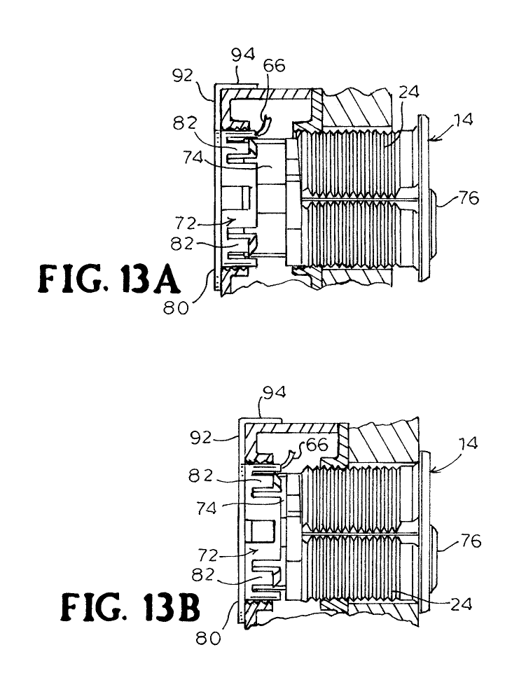

The inner portion 78 of the monitor housing 72 is received in the cylinder opening 30 in the lock case 12 in the same manner as the previous embodiment. Referring to FIGS. 13A and 13B, in this embodiment the extension 92 lies against the wall of the case and flange 94 fits into a slot 98 in the top wall of the case 12. In use, this embodiment of the lock cylinder monitoring assembly 70 functions the same way as the previous embodiment. As the lock cylinder 14 is threaded into the opening 30 in the lock case 12, the plunger 74 initially engages the cam 28 and is pushed into the housing 72 against the force of the spring 76 until the trim flange 32 on the lock cylinder 14 is flush against the door surface. In use, the switch integral with the plunger 74 senses the magnet 29 in the cam 28. Accordingly, the switch generates an electric signal indicating that the cam 28 has moved, which signal is communicated via the electrical wiring 66.

It is understood that the embodiments of the lock cylinder monitoring assembly described herein may be retrofit to existing single cylinder mortise lock designs. The mortise lock assembly would be installed as a standard mortise lock assembly, except that the wiring from the switch to the indicator would need to be provided.

Although the present invention has been shown and described in considerable detail with respect to only a few exemplary embodiments thereof, it should be understood by those skilled in the art that we do not intend to limit the invention to the embodiments since various modifications, omissions and additions may be made to the disclosed embodiments without materially departing from the novel teachings and advantages of the invention, particularly in light of the foregoing teachings. Accordingly, we intend to cover all such modifications, omission, additions and equivalents as may be included within the spirit and scope of the invention as defined by the following claims. In the claims, means-plus-function clauses are intended to cover the structures described herein as performing the recited function and not only structural equivalents but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

We claim:

1. A cylinder lock monitor for monitoring the cylinder lock position, comprising:
a cylinder lock monitor housing positioned proximate to a cylinder lock, the monitor housing having an inner cavity and an exterior diameter, the exterior diameter of the housing being no greater than the corresponding cylinder lock diameter; and
a switch housed within the inner cavity of the monitor housing, the switch in electrical communication with an indicator and reactive to any change in position of the cylinder lock.

2. The cylinder lock monitor of claim 1 wherein the cylinder lock has a rotating cam and the monitor housing is mounted adjacent to the cam.

3. The cylinder lock monitor of claim 2 wherein the switch is spring mounted adjacent to the cam.

4. The cylinder lock monitor of claim 1 wherein the switch is a Reed switch the cam has a magnet mounted in or on the cam.

5. The cylinder lock monitor of claim 1 wherein the switch is wired to an indicator at a remote location.

6. The cylinder lock monitor of claim 5 wherein the indicator is in electrical communication with an alarm system.

7. A cylinder lock assembly comprising:
a cylinder lock; and
a cylinder lock monitor for monitoring the cylinder lock's position, the monitor comprising a housing having an inner cavity and an exterior diameter, the exterior diameter being no greater than the corresponding cylinder diameter, a switch received into the inner cavity of the housing, the switch in electrical communication with an indicator and reactive to any change in position of the cylinder lock.

8. The cylinder lock assembly of claim 7 wherein the cylinder lock has a rotating cam and the monitor housing is mounted adjacent to the cam.

9. The cylinder lock assembly of claim 8 wherein the switch is spring mounted adjacent to the cam.

10. The cylinder lock assembly of claim 7 wherein the switch is a Reed switch the cam has a magnet mounted in or on the cam.

11. The cylinder lock assembly of claim 7 wherein the switch is wired to an indicator at a remote location.

12. The cylinder lock assembly of claim 11 wherein the indicator is in electrical communication with an alarm system.

13. A mortise lock assembly comprising:
a mortise lock body;
a cylinder lock; and
a cylinder lock monitor assembly for monitoring the cylinder lock's position, the monitor assembly comprising a housing having an inner cavity and an exterior diameter, the exterior diameter being no greater than the corresponding cylinder lock diameter, a switch received into the inner cavity of the housing, the switch in electrical communication with an indicator and reactive to any change in position of the cylinder lock.

14. The mortise lock assembly of claim 13 wherein the cylinder lock has a rotating cam and the monitor housing is mounted adjacent to the cam.

15. The mortise lock assembly of claim 14 wherein the switch is spring mounted adjacent to the cam.

16. The mortise lock assembly of claim 13 wherein the switch is a Reed switch and the cam has a magnet mounted in or on the cam.

17. The mortise lock assembly of claim 13 wherein the switch is wired to an indicator at a remote location.

18. The mortise lock assembly of claim 13 wherein the indicator is in electrical communication with an alarm system.

19. A method for monitoring the position of a cylinder lock, comprising the steps of:
locating a cylinder lock within a cylinder lock cavity within a mortise lock assembly, the cylinder lock cavity having an exterior end adjacent to the exterior of the door surface and an interior end, the cylinder lock having a cam located at the interior end of the cylinder lock cavity,
mounting a cylinder lock monitor assembly at the interior end of the cylinder lock cavity, the cylinder lock monitor assembly having a housing having an inner cavity and an exterior diameter, the exterior diameter being no greater than the corresponding cylinder diameter, a switch received into the inner cavity of the housing, the switch in electrical communication with an indicator and reactive to any change in position of the cylinder lock; and
supplying electrical power to the switch.

20. The method of monitoring the position of a cylinder lock of claim 19 wherein the switch is wired to an indicator at a remote location.

21. The method of monitoring the position of a cylinder lock of claim 20 wherein the indicator is in electrical communication with an alarm system.

22. The method of monitoring the position of a cylinder lock of claim 19 further comprising the step of mounting a magnet on or in the cam and wherein the switch is a Reed switch.

23. The method of monitoring the position of a cylinder lock wherein the cylinder lock assembly is spring mounted to the interior end of the cylinder lock cavity.
